(19) United States
(12) Patent Application Publication
(10) Pub. No.: US 2010/0204430 A1
(43) Pub. Date: Aug. 12, 2010

(54) Continuous Production of Polyurethanes/Polyureas

(76) Inventors: Laurent Marc, Hericy (FR); Helmut Mack, Traunstein (DE)

Correspondence Address: CURATOLO SIDOTI CO., LPA, 24500 CENTER RIDGE ROAD, SUITE 280, CLEVELAND, OH, 44145, US

(21) Appl. No.: 12/675,233

(22) PCT Filed: Sep. 1, 2008
(86) PCT No.: PCT/EP08/61495

§ 371 Date: Apr. 1, 2010

(30) Foreign Application Priority Data
Sep. 12, 2007 (DE) 10 2007 043 509.8
Oct. 26, 2007 (DE) 10 2007 051 274.2

(51) Int. Cl. C08G 18/00

(52) U.S. Cl. 528/61; 528/66

(57) ABSTRACT

The invention relates to a continuous process for the preparation of polyurethanes/polyureas, in which the components of a starting reaction composition are applied individually and/or as a mixture in a thin film to an inner region of a hot surface of a rotating body A so that the thin film flows over the hot surface of the rotating body A to an outer region of the hot surface of the rotating body A, the thin film leaves the hot surface as polyurethane/polyurea-containing reaction composition and, after leaving the hot surface, the reaction composition is abruptly cooled, a polyisocyanate component and a polyol/polyamine component being present as components of the starting reaction composition, the temperature of the hot surface being 70 to 400° C. and the abrupt cooling of the reaction composition being at least 30° C.

The present invention relates to a process for the preparation of polyurethanes/polyureas, and polyurethanes/polyureas which can be prepared by this process.

Polyurethanes/polyureas have usually been prepared to date on the industrial scale in batchwise processes in which the generally known disadvantages of the batchwise procedure, such as long loading and unloading times, poor heat and mass transfer, varying quality of the products, etc., have an impact. In the continuous procedure for the preparation of polyurethane/polyurea which is strived for in the process intensification, these disadvantages should at least be less pronounced. However, there appears to date to be no corresponding satisfactory process intensification concept for the industrial production of polyurethanes/polyureas, which is possibly associated with the temperature sensitivity of the polyurethanes/polyureas.

From the point of view of the production technology, the belt process and the reaction extruder process are important as continuous processes. In this context, for the preparation of homogeneous polyurethanes having improved softening properties, DE-C-19 924 089 proposes a “one-shot metering process”, according to which first the total reaction mixture, comprising polyisocyanate, polyol and chain extender, is homogeneously mixed in a static mixer at high shear rates between 500 and 50,000 s⁻¹ at defined temperatures within short mixing times of not more than 1 s, and the reaction mixture thus prepared is metered into an extruder, optionally via a second static mixer. In DE-A-199 24 090, with the same process aim, the preparation of polyurethanes having improved softening behaviour, the formation of the reaction mixture is carried out in a stirred tubular reactor having defined ratios of stirring speed and throughput, and the polyurethane formation is then completed in an extruder.

Both processes serve in particular for the preparation of homogeneous polyurethane qualities having a lower softening temperature.

A substantial disadvantage of both processes is the lack of self-cleaning of the mixing apparatus (stirred tubular reactor). Thus, product deposits which lead to constriction and finally to closing of the free flow cross section of the tubular reactor and limit the stability and the continuity of the preparation process form in dead zones in the process.

It is an object of the present invention to provide a procedurally flexible and economical process for the preparation of polyurethanes/polyureas, which ensures a good product quality.

This object is achieved by a process for the preparation of polyurethanes/polyureas which is carried out in a continuous mode of operation in a reactor which has
α) a body A rotating about an axis of rotation and having a hot surface,
β) a metering system and
γ) a quench apparatus,
a) the components of a starting reaction composition, individually and/or as a mixture being applied with the aid of the metering system in a thin film on an inner region of the hot surface of the rotating body A so that the thin film flows over the hot surface of the rotating body A to an outer region of the hot surface of the rotating body A,
b) the thin film leaving the hot surface as a polyurethane/polyurea-containing reaction composition and
c) the reaction composition being cooled abruptly by means of the quench apparatus after leaving the hot surface,
i) a polyisocyanate component containing polyisocyanates and
ii) a polyol/polyamine component comprising polyols and/or polyamines
   being present as components of the starting reaction composition, the temperature of the hot surface being 70 to 400° C. and the abrupt cooling of the reaction composition by means of the quench apparatus being at least 30° C.

The reactor in which the process according to the invention is carried out permits a procedure in which the combination of preferably short residence times and high reaction temperatures is realized. Thus, the process according to the invention ensures that the components of the starting reaction composition are heated abruptly and strongly and reacted correspondingly rapidly, the product obtained being protected from undesired thermal secondary reactions by subsequent quenching of the product obtained. The abrupt cooling of the reaction composition by means of the quench apparatus is effected within not more than five seconds, preferably within only one second.

The process according to the invention offers the possibility of flexible and simple process optimization. It is virtually possible to apply a wide range of components as components of the starting composition to various points of the hot surface. The scale-up which is often problematic in process engineering is particularly simple owing to the simplicity and the usually relatively small size of the reactor used. Furthermore, it should be mentioned that both the capital costs and the maintenance costs (cleaning, etc.) of said reactor are very low. In addition, the quality of the product obtained. i.e. of the polyurethane/polyurea-containing reaction composition, can easily be varied in a targeted manner by changing the process parameters (residence time, temperature, metering of the components of the starting reaction composition).

In a preferred embodiment of the invention, the molar ratio of the isocyanate groups of the polyisocyanate component used to the sum of the amino groups and hydroxyl groups of the polyol/polyamine component used is 0.1 to 10, preferably 0.7 to 1.3.

Frequently, not only are corresponding ratios of polyisocyanates and polyol/polyamines used as components of the starting reaction composition in the process according to the invention but often plasticizers, lubricants, molecular chain regulators, flameproofing agents, inorganic/organic fillers, dyes, pigments and stabilizers (with regard to hydrolysis, light and thermal degradation), chain extenders, solvents and catalysts are also employed as further components.

As is generally customary in polyurethane chemistry, species containing 4 to 30 C atoms and having aliphatically, cycloaliphatically, araliphatically and/or aromatically bonded isocyanate groups can be used as polyisocyanates. The diisocyanates are preferred. Diisocyanates (X(NCO)₂, where X represents an aliphatic hydrocarbon radical having 4 to 12 carbon atoms, a cycloaliphatic or aromatic hydrocarbon radical having 6 to 15 carbon atoms or an araliphatic hydrocarbon radical having 6 to 15 carbon atoms, may be mentioned in particular. Examples of suitable aromatic polyisocyanates are the isomers of toluylene diisocyanate (TDI) and in particular either in the form of pure isomers or as an isomer mixture. Specific examples of corresponding species are 1,5-naphthaline diisocyanate, 4,4′-diphenylmethane diisocyanate (4,4-MDI) or 2,4′-diphenylmethane diisocyanate (2,4-MDI) or polymeric MDI (and in particular either in the form of pure isomers or as isomer mixtures).

Suitable cycloaliphatic polyisocyanates are hydrogenation products of the abovementioned aromatic diisocyanates, such as, for example, 4,4′-dicyclohexylmethane diisocyanate (H₁₂MDI), 1-isocyanatomethyl-3-isocyanato-1,5-trimethylcyclohexane (isophorone diisocyanate, IPDI), 1,4-cyclohexane diisocyanate, hydrogenated xylylene diisocyanate (H₆XDI), 1-methyl-2,4-diisocyanatocyclohexane, m- or p-tetramethylxylene diisocyanate (m-TMXDI, p-TMXDI) and dimer fatty acid diisocyanate. Suitable aliphatic polyisocyanates are 1,4-tetramethoxybutane diisocyanate, 1,4-butane diisocyanate, 1,6-hexane diisocyanate (HDI), 1,6-diisocyanato-2,2,4-trimethylhexane, 1,6-diisocyanato-2,4,4-trimethylhexane and 1,12-dodecane diisocyanate (C₁₂DI). Polyisocyanate prepared by modification of simple aliphatic, cycloaliphatic, araliphatic and/or aromatic diisocyanates, composed of at least two diisocyanates and having a uretdione, isocyanurate, urethane, allophanate, biuret, iminooxadiazinedione and/or oxadiazinetrione structure are furthermore suitable.

In the case of monoisocyanates, oligomeric urethanes/ureas are available.

In the present invention, the choice of the polyol component is not critical. Both low molecular weight polyols and higher molecular weight polyols/polyamines can be used as the polyol/polyamine component. Suitable polyols are preferably the polyhydroxy compounds which are liquid, solid/amorphous and glassy or crystalline at room temperature and have two or three hydroxyl groups per molecule and a molecular weight (number average) of 400 to 200,000, preferably of 1,000 to 18,000. Difunctional polypropylene glycols may be mentioned as typical examples. Random copolymers and/or block copolymers of ethylene oxide and propylene oxide which have hydroxyl groups may also be used. Suitable polyetherpolyols are the polyethers known per se in polyurethane chemistry, such as the polyols prepared using initiator molecules and comprising styrene oxide, propylene oxide, butylene oxide or epichlorohydrin. Specifically, poly(oxytetramethylene)glycol (poly-THF), 1,2-polybutylene glycol or mixtures thereof are also particularly suitable. Preferred molecular weight ranges (number average) for suitable polyether species are 400 to 200,000, in particular 1,000 to 18,000. A further copolymer type which can be used as the polyol component and has terminal hydroxyl groups is according to the general formula (preparable, for example, by means of “controlled” high-speed anionic polymerization according to Macromolecules 2004, 37, 4038-4043):

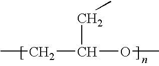

in which R is identical or different and is preferably represented by OMe, OiPr, Cl or Br.

Other suitable polyol components are the liquid, amorphous and glassy or crystalline polyesters which can be prepared by condensation of di- or tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid and/or dimer fatty acid, with low molecular weight diols or triols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol and/or trimethylolpropane.

A further suitable group of polyols comprises the polyesters based on caprolactone, which are also referred to as “polycaprolactones”. Further polyols which may be used are polycarbonate-polyols and dimer diols and castor oil and derivatives thereof. Polycarbonates which have hydroxyl groups and are obtainable by reaction of carbonic acid derivatives, e.g. diphenyl carbonate, dimethyl carbonate or phosgene, with diols are also suitable. Specifically, ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, glycerol, trimethylolpropane, 1,2,6-hexanetriol, 1,2,4-butanetriol, trimethylolpropane, pentaerythritol, quinitol, mannitol, sorbitol, methylglycoside and 1,3,4,6-dianhydrohexitols are suitable. The hydroxy-functional polybutadienes which are commercially available, inter alia, under the trade name “Poly-bd®” can be used as polyols, as can the hydrogenated analogues thereof. Furthermore, hydroxy-functional polysulphides, which are sold under the trade name “Thiokol® NPS-282”, and hydroxy-functional polysiloxanes are furthermore suitable.

Hydrazine, hydrazine hydrate and substituted hydrazines, such as N-methylhydrazine, N,N′-dimethylhydrazine, acid dihydrazides, adipic acid, methyladipic acid, sebacic acid, hydracrylic acid, terephthalic acid, semicarbazidoalkylene hydrazides, such as 13-semicarbazidopropionic acid hydrazide, semicarbazidoalkylene carbazine esters, such as, for example, 2-semicarbazidoethyl carbazine ester, and/or aminosemicarbazide compounds, such as 13-aminoethylsemicarbazido carbonate, are particularly suitable as polyamines which can be used according to the invention.

Polyamines, for example those which are sold under the trade name Jeffamine® (in the case of polyetherpolyamines), are also suitable.

The polyol/polyamine component used according to the invention usually contains either exclusively polyols or mixtures of polyols and polyamines.

Other suitable polyol/polyamine components are the species known as so-called chain extenders, which react with excess isocyanate groups, usually have a molecular weight of less than 400 and are frequently present in the form of polyols, aminopolyols or aliphatic, cycloaliphatic or araliphatic polyamines.

Suitable chain extenders are, for example:
alkanediols, such as ethanediol, 1,2- and 1,3-propanediol, 1,4- and 2,3-butanediol, 1,5-pentanediol, 1,3-dimethylpropanediol, 1,6-hexanediol, neopentylglycol, cyclohexanedimethanol, 2-methyl-1,3-propanediol,
ether diols, such as diethylene diglycol, triethylene glycol or hydroquinone dihydroxyethyl ether,
hydroxybutylhydroxycaproic acid ester, hydroxyhexylhydroxybutyric acid ester, hydroxyethyl adipate and bishydroxyethyl terephthalate and
polyamines, such as ethylenediamine, 1,2- and 1,3-diaminopropane, 1,4-diaminobutane, 1,6-diaminohexane, isomer mixture of 2,2,4- and 2,4,4-trimethylhexamethylenediamine, 2-methylpentamethylenediamine, diethylenetriamine, 1,3- and 1,4-xylylenediamine and 4,4-diaminodicyclohexylmethane.

Finally, it should be mentioned that the polyol/polyamine component may contain species having double bonds, which can result, for example, from long-chain, aliphatic carboxylic acids or fatty alcohols. Functionalization with olefinic double bonds is possible, for example, by the incorporation of allylic groups or of acrylic acid or methacrylic acid and the respective esters thereof.

Solvents may be used as components of the starting reaction composition (the solvent may escape through boiling during the reaction or remain in the mixture). Suitable solvents are, for example, ethyl acetate, butyl acetate, 1-methoxyprop-2-yl acetate, 3-methoxy-n-butyl acetate, 2-butanone, 4-methyl-2-pentanone, cyclohexanone, toluene, xylene, chlorobenzene or mineral spirit. Solvent mixtures which contain especially aromatics having a relatively high degree of substitution, for example commercially available as Solvent Naphtha, Solvesso® (Exxon Chemicals, Houston, USA), Cypar® (Shell Chemicals, Eschborn, Germany), Cyclo Sol® (Shell Chemicals, Eschborn, Germany), Tolu Sol® (Shell Chemicals, Eschborn, Germany), Shellsol® (Shell Chemicals, Eschborn. Germany), are likewise suitable. Other solvents which may be used are carbonic acid esters, such as dimethyl carbonate, diethyl carbonate, 1,2-ethylene carbonate, and 1,2-propylene carbonate; lactones, such as 1,3-propiolactone, isobutyrolactone, caprolactone, methylcaprolactone, propylene glycol diacetate, diethylene glycol dimethyl ether, dipropylene glycol dimethyl ether, diethylene glycol ethyl acetate, N-methylpyrrolidone and N-methylcaprolactam.

In a preferred embodiment of the invention, no catalyst suitable for the preparation of polyurethanes is used in the process according to the invention. This process variant is used in particular at high temperatures and with the use of reactive starting components. The absence of the catalyst in the polymeric product of the process is to be regarded as a substantial qualitative advantage.

On the other hand, not rarely, however, is a catalyst suitable for the preparation of polyurethanes used as a component of the starting reaction composition in the process according to the invention. Suitable catalysts are the customary catalysts of polyurethane chemistry which are known per se and have atoms such as, for example, Sn, Mn, V, Fe, Co, Cd, Ni, Cu, Zn, Zr, Ti, Hf, Al, Th, Ce, Bi, N or P. The molar catalyst/isocyanate ratio is dependent on the type of isocyanate and the type of catalyst and is usually from 0 to 0.1, preferably 0 to 0.03.

Usually, the process parameters are set so that at least 93%, preferably at least 98%, of the isocyanate groups of the polyisocyanate component which can be reacted at most with the amount of polyols and polyamines used have reacted with hydroxyl and/or amino groups of the polyol/polyamine component after the abrupt cooling of the reaction composition by means of the quench apparatus. In this context, in particular the temperature, the residence time, the layer thickness of the applied film, the metering, type and concentration of the components of the starting reaction composition which are used may be mentioned as process parameters.

The body A which rotates about an axis of rotation and has a hot surface is preferably present as a horizontal rotating disc or a rotating disc deviating slightly (at an angle of up to about 30°) from the horizontal. Alternatively, the body A having the hot surface may also be vase-shaped, annular or conical. Usually, the body A having the hot surface has a diameter of 0.10 m to 3.0 m, preferably 0.20 m to 2.0 m and particularly preferably 0.20 m to 1.0 m. The hot surface may be smooth or alternatively may have ripple-like or spiral indentations which influence the residence time of the reaction mixture. Expediently, the body A having the hot surface is installed in a container which is resistant under the conditions of the process according to the invention.

The temperature of the hot surface is preferably between 100 and 300° C., particularly preferably between 120 and 250° C. The temperature of the hot surface is an important parameter which should be tailored by the person skilled in the art to other relevant influencing variables, such as residence time, and type and amount of the components of the starting reaction mixture.

In a special embodiment of the invention, the hot surface extends to further rotating bodies, so that, before the cooling by means of the quench apparatus, the reaction composition passes from the hot surface of the rotating body A to the hot surface of at least one further rotating body having the hot surface. The further rotating bodies expediently have a character corresponding to that of the body A. Typically, the body A virtually feeds the further bodies with the reaction mixture, i.e. the thin film flows from the body A to at least one further body and leaves this at least one further body in order subsequently to be cooled abruptly by means of the quench apparatus.

The quench apparatus is in general preferably in the form of one or more cooling walls which permit the abrupt cooling of the reaction mixture. The cooling walls, which are frequently cylindrical or conical, have either a smooth or a rough surface, the temperature of which is typically between −50° C. and 200° C. The abrupt cooling of the reaction composition which is effected by means of the quench apparatus is preferably at least 50° C. preferably at least 100° C.

In a preferred embodiment, the metering system used makes it possible for the components of the starting reaction composition to be added at any desired positions of the hot surface. A portion or the total components of the starting reaction composition can be premixed and can be applied to the hot surface only thereafter by means of the metering system.

In a particularly preferred embodiment of the invention, the rotating body A is present as a rotating disc which has the hot surface at the top and to which the components of the starting reaction composition are applied individually and/or as a mixture with the aid of the metering system in the middle region as a thin film, and the quench apparatus is present as a cooling wall which surrounds the rotating disc and which the reaction composition meets after leaving the hot surface.

The rotational velocity of the body A having the hot surface and the metering rate of the components of the starting reaction mixture are variable. Usually, the rotational velocity in revolutions per minute is 1 to 20,000, preferably 100 to 5,000 and particularly preferably 500 to 2,000. The volume of the reaction mixture which is present on the rotating body A per unit area of the hot surface is typically 0.1 to 10 mL/dm², preferably 1.0 to 5.0 mL/dm². The average residence time (frequency average of the residence time spectrum) of the reaction mixture is dependent, inter alia, on the size of the hot surface, on the type and amount of the components of the starting reaction mixture, on the temperature of the hot surface and on the rotational velocity of the rotating body A and is usually 0.01 to 100 s, preferably 0.1 to 10 s, particularly preferably 1 to 10 s, and is therefore to be regarded as being extremely short. This ensures that the extent of the undesired secondary reaction is greatly reduced and products of high quality are therefore produced.

In a preferred embodiment of the invention, a layer thickness of 0.1 μm to 1.0 mm, preferably of 20 to 80 μm of the thin film applied by means of the metering system and a frequency-average residence time of 0.01 to 20 seconds, preferably of 0.1 to 10 seconds, of the components of the starting reaction composition on the hot surface are set as process parameters.

The process according to the invention is preferably carried out at atmospheric pressure and in an atmosphere of dry inert gas, it being possible, however, alternatively to operate the process in vacuo for degassing the residual isocyanate or under pressure for increasing the temperature.

Finally, the present invention also relates to polyurethanes/polyureas which can be prepared by the process described above.

Below, the invention is to be described in more detail with reference to working examples.

### EXAMPLES

In all examples, a reactor type from Protensive Limited, as described in the documents WO00/48728, WO00/48729, WO00/48730, WO00/48731 and WO00/48732, was used.

The body A is a disc which has a diameter of 20 cm or 10 cm and different surfaces. This body A can be cooled or heated with liquid in a range from −50° C. to +250° C. and can rotate at from 10 rpm (rpm=revolutions per minute) to 3,000 rpm. A gear pump will meter in the premix under nitrogen.

The quench apparatus is a metallic wall in which coolant flows.

### Example 1

### Polyol with Aliphatic Isocyanate

396 g of Lupranol® 1000 (polypropylene glycol synthesized with KOH technology, diol, molar mass about 2000 g/mol, OH number 55, viscosity 325 mPa·s) from Elastogran, 104 g of Vestanat® IPDI (isophorone diisocyanate, CAS 4098-71-9) from Degussa GmbH, 1.50 g of additive TI (p-toluenesulphonyl isocyanate (PTSI), CAS 4083-64-1) from Borchers and 0.2 g of DBTDL (dibutyltin dilaurate, CAS (Chemical Abstracts Service) 77-58-7) were initially introduced into a 1 l container. The mixture is stirred for 30 minutes at room temperature with a KPG stirrer. The body A, present as a smooth disc having a diameter of 20 cm, is heated with oil at 180° C. and rotated at 400 rpm. The premix is metered in at 5.00 ml/s under nitrogen by means of a gear pump. The polyurethane/polyurea product is cooled by cooled (−10° C.) walls. It leaves the system at 50° C. with an NCO residue of 4.49% by weight. The conversion is about 100% with a viscosity (measured according to DIN EN ISO 2555 EN, as in the examples below) of 6250 mPa·s.

### Example 2

### Polyol Mixture with Aromatic Isocyanate

625 g of Pluracol 1044 S (polypropylene glycol synthesized by means of KOH technology, diol, molar mass about 4000 g/mol, OH number 30, viscosity 790 mPa·s) from BASF AG, 375 g of Pluracol 220 S (polypropylene glycol synthesized by means of KOH technology, triol, molar mass about 6000 g/mol, OH number 26, viscosity 1300 mPa·s) from BASF AG and 0.28 g of bismuth octanoate (CAS 67874-71-9) were initially introduced into a 2 L container and mixed with a KPG stirrer. 90.8 g of Desmophen T-80 TDI (CAS 584-84-9) from Bayer AG were mixed with 0.5 g of additive TI (p-toluenesulphonyl isocyanate (PTSI), CAS 4083-64-1) from Borchers in a 200 mL container. The body A, a doubly rippled disc having a diameter of 20 cm, is heated at 150° C. with oil and rotates at 1000 rpm. By means of two gear pumps, the polyol/catalyst premix is metered at 4.58 g/s and the isocyanate premix at 0.42 g/s under nitrogen into a static mixer. This static mixer delivers a continuous premix of 5.00 g/s onto the body A. The polyurethane/polyurea product is cooled by cooled (−10° C.) walls. It leaves the system at 50° C. with an NCO residue of 2.11% by weight. The conversion is about 100% with a viscosity of 13800 mPa·s.

### Example 3

### Polyol, Chain Extender with Aliphatic Isocyanate

990 g of Acclaim® 8200N (polypropylene glycol synthesized by means of DMC technology, diol, molar mass about 8000 g/mol, OH number 14, viscosity 3000 mPa·s) from Bayer AG, 10 g of hexylene glycol (CAS 107-41-5), 69 g of Basonat® I (isophorone diisocyanate, CAS 4098-71-9) from BASF AG and 1.6 g of bismuth octanoate (CAS 67874-71-9) were initially introduced into a 2 L container. The mixture is stirred for 30 minutes at room temperature with a KPG stirrer. The body A, a smooth disc having a diameter of 20 cm, is heated at 180° C. with oil and rotates at 400 rpm. By means of a gear pump, the premix is metered in at 5.00 ml/s under nitrogen. The polyurethane/polyurea product is cooled by cooled (−10° C.) walls. It leaves the system at 50° C. with an NCO residue of 0.9% by weight. The conversion is about 100% with a viscosity of 30,000 mPa·s.

### Example 4

### Polyol, Chain Extender with Aliphatic Isocyanate on Relatively Small Disc

990 g of Acclaim® 8200N (polypropylene glycol synthesized by means of DMC technology, diol, molar mass about 8000 g/mol, OH number 14, viscosity 3000 mPa·s) from Bayer AG, 10 g of hexylene glycol (CAS 107-41-5), 69 g of Basonat® I (isophorone diisocyanate, CAS 4098-71-9) from BASF AG and 1.6 g of bismuth octanoate (CAS 67874-71-9) were initially introduced into a 2 L container. The mixture is stirred for 30 minutes at room temperature with a KPG stirrer. The body A, a smooth disc having a diameter of 10 cm, is heated at 180° C. with oil and rotates at 400 rpm. By means of a gear pump, the premix is metered in at 1.25 ml/s under nitrogen. The polyurethane/polyurea product is cooled by cooled (−10° C.) walls. It leaves the system at 50° C. with an NCO residue of 0.9% by weight. The conversion is about 100% with a viscosity of 30,000 mPa·s.

### Example 5

### Polyol/Diamine with Aromatic Isocyanate without Catalyst

990 g of Acclaim® 8200N (polypropylene glycol synthesized by means of DMC technology, diol, molar mass about 8000 g/mol, OH number 14, viscosity 3000 mPa·s) from Bayer AG and 10 g of ethylenediamine (CAS 107-15-3) were initially introduced into a 2 L container and mixed with a KPG stirrer. 81.4 g of Desmodur® VP (mixture which consists of about 55% of 2,4′-MDI and about 45% of 4,4′-MDI) were initially introduced into a 200 mL container. Owing to the high 2,4′-methylenediphenyl diisocyanate (2,4′-MDI) content, it is liquid at room temperature. The body A, a smooth disc having a diameter of 20 cm, is heated at 180° C. with oil and rotates at 1000 rpm. By means of two gear pumps the polyol/diamine premix is metered at 4.68 g/s and the isocyanate premix at 0.32 g/s under nitrogen into a static mixer. This static mixer delivers a continuous premix of 5.00 g/s on the body A. The polyurethane/polyurea product is cooled by cooled (−10° C.) walls. It leaves the system at 50° C. with an NCO residue of 2.31% by weight. The conversion is about 100% with a viscosity of 35,400 mPa·s.

In all examples, the reactions on the disc were complete in less than 2 seconds owing to the high temperatures. The quench apparatus permits the collection of products without secondary reactions. The products leave the machine after a few seconds. The process is completely continuous and can be ended abruptly. With the comparison between Examples 4 and 3, the scale-up is successful and simple. No cleaning process is necessary between the batches since the first 50 ml of impure product were removed. Furthermore, no encrustations or variations of the viscosity and of the residual amount of NCO are noticeable in continuous operation.

1. Process for the preparation of polyurethanes/polyureas which is carried out in a continuous mode of operation in a reactor which has
α) a body A rotating about an axis of rotation and having a hot surface,
β) a metering system and
γ) a quench apparatus,
a) the components of a starting reaction composition, individually and/or as a mixture being applied with the aid of the metering system in a thin film on an inner region of the hot surface of the rotating body A so that the thin film flows over the hot surface of the rotating body A to an outer region of the hot surface of the rotating body A,
b) the thin film leaving the hot surface as a polyurethane/polyurea-containing reaction composition and
c) the reaction composition being cooled abruptly by means of the quench apparatus after leaving the hot surface,
i) a polyisocyanate component containing polyisocyanates and
ii) a polyol/polyamine component comprising polyols and/or polyamines
being present as components of the starting reaction composition,
the temperature of the hot surface being 70 to 400° C. and the abrupt cooling of the reaction composition by means of the quench apparatus being at least 30° C.

2. Process according to claim 1, characterized in that the molar ratio of the isocyanate groups of the polyisocyanate component used to the sum of the amino groups and hydroxyl groups of the polyol/polyamine component used is 0.1 to 10, optionally 0.7 to 1.3.

3. Process according to claim 1, characterized in that the process parameters are set so that at least 93%, optionally at least 98%, of the isocyanate groups of the polyisocyanate component which can be reacted at most with the amount of polyols and polyamines used have reacted with hydroxyl and/or amino groups of the polyol/polyamine component after the abrupt cooling of the reaction composition by means of the quench apparatus.

4. Process according to claim 1, characterized in that the hot surface extends to further rotating bodies so that, before the cooling by means of the quench apparatus, the reaction composition passes from the hot surface of the rotating body A to the hot surface of at least one of the further rotating bodies having the hot surface.

5. Process according to claim 1, characterized in that the rotating body A is present as a rotating disc having a top which has the hot surface at the top and to which the components of the starting reaction composition are applied individually and/or as a mixture with the aid of the metering system in the middle region as a thin film and the quench apparatus is present as a cooling wall which surrounds the rotating disc and which the reaction composition meets after leaving the hot surface.

6. Process according to claim 1, characterized in that the temperature of the hot surface is between 100 and 300° C., optionally between 120 and 250° C.

7. Process according to claim 1, characterized in that no catalyst suitable for the preparation of polyurethanes is used.

8. Process according to claim 1, characterized in that a catalyst suitable for the preparation of polyurethanes is present as a component of the starting reaction composition.

9. Process according to claim 1, characterized in that the abrupt cooling of the reaction composition which is effected by means of the quench apparatus is at least 50° C., preferably optionally at least 100° C.

10. Process according to claim 1, characterized in that
a layer thickness of 0.1 μm to 1.0 mm, optionally of 20 to 80 μm, of thin film applied by means of the metering system and
a frequency-average residence time of 0.01 to 20 seconds, optionally of 0.1 to 10 seconds, of the components of the starting reaction composition on the hot surface are set as process parameters.

11. Polyurethane/polyurea prepared by the process according to claim 1.
